(19) United States
(12) Patent Application Publication
(10) Pub. No.: US 2025/0296350 A1
(43) Pub. Date: Sep. 25, 2025

(54) LIQUID DISCHARGE APPARATUS, PRINTING APPARATUS, LIQUID DISCHARGE METHOD, AND A NON-TRANSITORY RECORDING MEDIUM

(71) Applicants: Sayuri KOJIMA, Kanagawa (JP); Takahiro YOSHIDA, Kanagawa (JP)

(72) Inventors: Sayuri KOJIMA, Kanagawa (JP); Takahiro YOSHIDA, Kanagawa (JP)

(21) Appl. No.: 19/082,183

(22) Filed: Mar. 18, 2025

(30) Foreign Application Priority Data
Mar. 22, 2024 (JP) 2024-045898

(51) Int. Cl. B41J 2/21; B41J 2/045

(52) U.S. Cl. CPC B41J 2/2132; B41J 2/04505; B41J 2/04581

(57) ABSTRACT

A liquid discharge apparatus includes a first head including first nozzle arrays each including first nozzles arrayed in a nozzle array direction to discharge droplets from the first nozzles to a medium; and a second head including second nozzle arrays each including second nozzles arrayed in the nozzle array direction to discharge droplets from the second nozzles to a medium; and circuitry configured to control the first head and the second head to discharge the droplets from the first nozzles and the second nozzles, respectively. The first head and the second head are adjacent to each other in a transverse direction intersecting the nozzle array direction, the first head has a first overlap region at one end of the first head in the nozzle array direction, and the second head has a second overlap region overlapped with the first overlap region in the transverse direction.

### CROSS-REFERENCE TO RELATED APPLICATIONS

This patent application is based on and claims priority pursuant to 35 U.S.C. § 119 (a) to Japanese Patent Application No. 2024-045898, filed on Mar. 22, 2024, in the Japan Patent Office, the entire disclosure of which is hereby incorporated by reference herein.

### BACKGROUND

### Technical Field

The present embodiment relates to a liquid discharge apparatus, a printing apparatus, a liquid discharge method, and a program.

### Related Art

In recent years, a liquid discharge apparatus has been demanded to cope with, for example, an increase in the conveyance speed of a discharge target for implementing high productivity and a wide medium (print medium) as a discharge target object. In a case of configuring a long head group by arranging a plurality of discharge heads in order to cope with a wide print medium, in order to reduce image quality degradation due to alignment accuracy between the heads and image quality degradation due to discharge variation of the heads and the like, discharge nozzles and non-discharge nozzles are selected by overlapping nozzles at end portions of adjacent heads, and image quality degradation of the overlapping region is reduced.

### SUMMARY

In an aspect of the present disclosure, a liquid discharge apparatus is provided that includes: a first head including first nozzle arrays each including first nozzles arrayed in a nozzle array direction to discharge droplets from the first nozzles to a medium; and a second head including second nozzle arrays each including second nozzles arrayed in the nozzle array direction to discharge droplets from the second nozzles to a medium; and circuitry configured to control the first head and the second head to discharge the droplets from the first nozzles and the second nozzles, respectively. The first head and the second head are adjacent to each other in a transverse direction intersecting the nozzle array direction, the first head has a first overlap region at one end of the first head in the nozzle array direction, the second head has a second overlap region overlapped with the first overlap region in the transverse direction, the second overlap region at another end of the second head opposite to the one end of the first head in the nozzle array direction, the first nozzles, arrayed in the same row in the nozzle array direction in each of the first nozzle arrays, and the second nozzles, arrayed in the same row in the nozzle array direction in each of the second nozzle arrays, are arrayed in a straight line in the transverse direction, and the circuitry is further configured to, in each of the first overlap region and the second overlap region: cause one of the first head or the second head to: discharge the droplets from only one of the first nozzles in the same row of each of the first nozzle arrays or the second nozzles in the same row of each of the second nozzle arrays, to land the droplets arrayed in the straight line in the transverse direction on the medium; alternately discharge or non-discharge the droplets from the first nozzles in the nozzle array direction in each of the first nozzle arrays; and alternately discharge or non-discharge the droplets from the second nozzles in the nozzle array direction in each of the second nozzle arrays.

In another aspect of the present disclosure, a liquid discharge method is provided that includes discharging droplets, to a medium, from first nozzles, arrayed in a nozzle array direction, in each of first nozzle arrays of a first head; discharging droplets, to a medium, from second nozzles, arrayed in the nozzle array direction, in each of second nozzle arrays of a second head; controlling the first head and the second head to discharge the droplets from the first nozzles and the second nozzles, respectively, causing one of the first head or the second head to, in each of a first overlap region in the first head and a second overlap region in the second head: discharge the droplets from only one of the first nozzles in the same row of each of the first nozzle arrays or the second nozzles in the same row of each of the second nozzle arrays, to land the droplets arrayed in a straight line in a transverse direction intersecting the nozzle array direction on the medium; alternately discharge or non-discharge the droplets from the first nozzles in the nozzle array direction in each of the first nozzle arrays; and alternately discharge or non-discharge the droplets from the second nozzles in the nozzle array direction in each of the second nozzle arrays.

The first head and the second head are adjacent to each other in the transverse direction, the first head has the first overlap region at one end of the first head in the nozzle array direction, the second head has the second overlap region overlapped with the first overlap region in the transverse direction, the second overlap region at another end of the second head opposite to the one end of the first head in the nozzle array direction, and the first nozzles, arrayed in the same row in the nozzle array direction in each of the first nozzle arrays, and the second nozzles, arrayed in the same row in the nozzle array direction in each of the second nozzle arrays, are arrayed in the straight line in the transverse direction.

In further another aspect of the present disclosure, a non-transitory recording medium storing a plurality of instructions which, when executed by one or more processors, causes the one or more processors to perform a method in a computer that controls a liquid discharge head. The method includes discharging droplets, to a medium, from first nozzles, arrayed in a nozzle array direction, in each of first nozzle arrays of a first head; discharging droplets, to a medium, from second nozzles, arrayed in the nozzle array direction, in each of second nozzle arrays of a second head; controlling the first head and the second head to discharge the droplets from the first nozzles and the second nozzles, respectively, causing one of the first head or the second head to, in each of a first overlap region in the first head and a second overlap region in the second head: discharge the droplets from only one of the first nozzles in the same row of each of the first nozzle arrays or the second nozzles in the same row of each of the second nozzle arrays, to land the droplets arrayed in a straight line in a transverse direction intersecting the nozzle array direction on the medium; alternately discharge or non-discharge the droplets from the first nozzles in the nozzle array direction in each of the first nozzle arrays; and alternately discharge or non-discharge the droplets from the second nozzles in the nozzle array direction in each of the second nozzle arrays.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a schematic configuration of a printing apparatus according to a first embodiment;

FIG. 2 is a plan view of an example of a head unit of the printing apparatus;

FIG. 3 is a plan view illustrating a configuration of a plurality of adjacent heads;

FIG. 4 is a block diagram illustrating a system configuration example of a printing apparatus;

FIG. 5 is a functional block diagram related to droplet discharge control of each nozzle by a print control unit;

FIG. 6 is a diagram illustrating an example of landing dots of a comparative example in the periphery of a nozzle overlap region;

FIG. 7 is a graph illustrating an example of a relationship between a driving frequency and an appropriate discharge amount;

FIG. 8 is a diagram illustrating an example of landing dots of a comparative example formed when an appropriate discharge amount is lowered;

FIG. 9 is a diagram illustrating an example of landing dots in a case where droplets from two heads overlap and land at an overlapping portion;

FIG. 10 is a diagram illustrating an example of a mask pattern and formed landing dots according to the first embodiment;

FIG. 11 is a diagram illustrating another example of a mask pattern and formed landing dot according to the first embodiment;

FIG. 12 is a diagram illustrating another example of a mask pattern and formed landing dot according to the first embodiment; and

FIG. 13 is a schematic view illustrating an example of an electrode manufacturing apparatus according to a second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of a liquid discharge apparatus, a printing apparatus, a liquid discharge method, and a program will be described in detail with reference to the accompanying drawings.

### First Embodiment

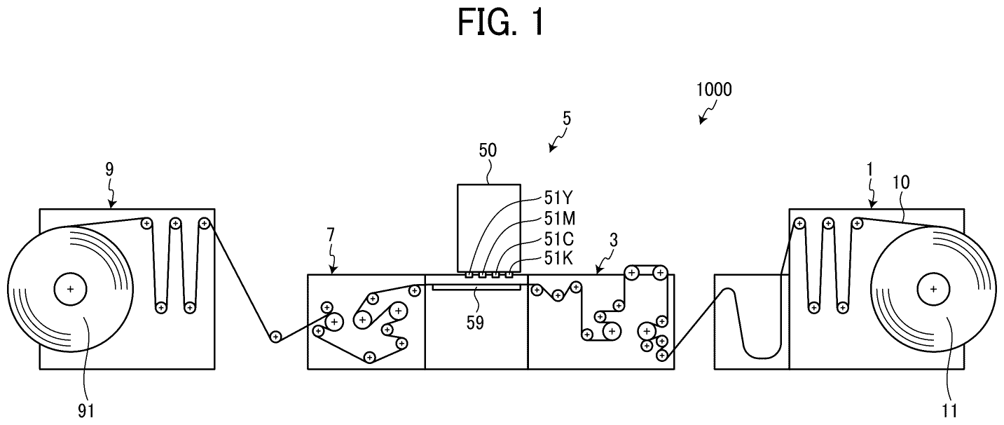

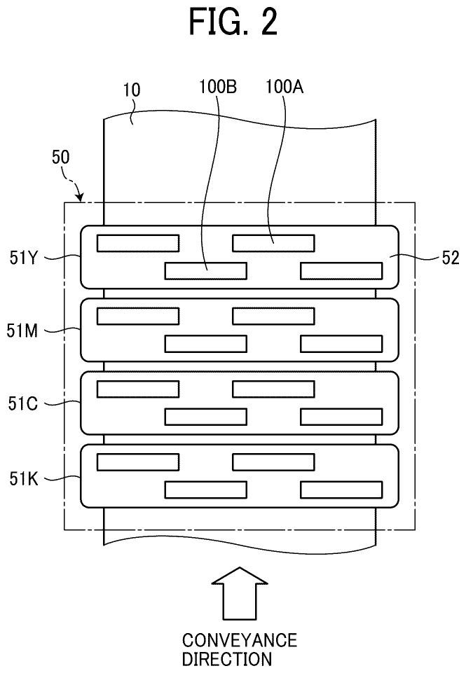

Here, FIG. 1 is a diagram illustrating a schematic configuration of a printing apparatus 1000 according to a first embodiment, and FIG. 2 is a plan view of an example of a head unit 50 of the printing apparatus 1000. The printing apparatus 1000 according to the present embodiment is a line type inkjet recording apparatus including a head unit 50 that is a line type head.

The printing apparatus 1000, which is a liquid discharge apparatus, includes a carry-in unit 1, a guide conveyance unit 3, a printing unit 5, a drying unit 7, and a discharging unit 9.

The carry-in unit 1 carries in the medium 10. The guide conveyance unit 3 guides and conveys the medium 10 carried in from the carry-in unit 1 to the printing unit 5. The printing unit 5 includes a head unit 50, and performs printing for forming an image by discharging liquid onto the medium 10. The drying unit 7 dries the medium 10. The discharging unit 9 discharges the medium 10.

The medium 10 is fed from the original winding roller 11 of the carry-in unit 1, guided and conveyed by respective rollers of the carry-in unit 1, the guide conveyance unit 3, the drying unit 7, and the discharging unit 9, and wound by a winding roller 91 of the discharging unit 9. As an example, the medium 10 of the printing apparatus 1000 is conveyed at a high speed of about 100 m/min.

In the printing unit 5, the medium 10 is conveyed on the conveyance guide member 59 so as to face the head unit 50. When the medium 10 is conveyed, an image is formed by liquid discharged from the head unit 50.

In the head unit 50, for example, full-line type head arrays 51K, 51C, 51M, and 51Y (hereinafter referred to as “head array 51” when colors are not distinguished) for four colors are arranged from the upstream side in a conveyance direction of the medium 10.

Each head array 51 is a liquid discharging unit, and discharges liquid (ink) of black K, cyan C, magenta M, and yellow Y onto the medium 10 to be conveyed. The number and types of color are not limited to these colors and may be any other number and types.

In the head array 51, for example, as illustrated in FIG. 2, a liquid discharge head (this is also simply referred to as a “head”) 100A and a head 100B, which are discharging heads that discharge liquid, are arranged in a staggered manner on a base member 52. Here, the head 100A is a head on the upstream side with respect to the conveyance direction, and the head 100B is a head on the downstream side with respect to the conveyance direction. By arranging the multiple heads side by side in this manner, it is possible to cope with a wide medium. The configuration of the head array 51 is not limited thereto.

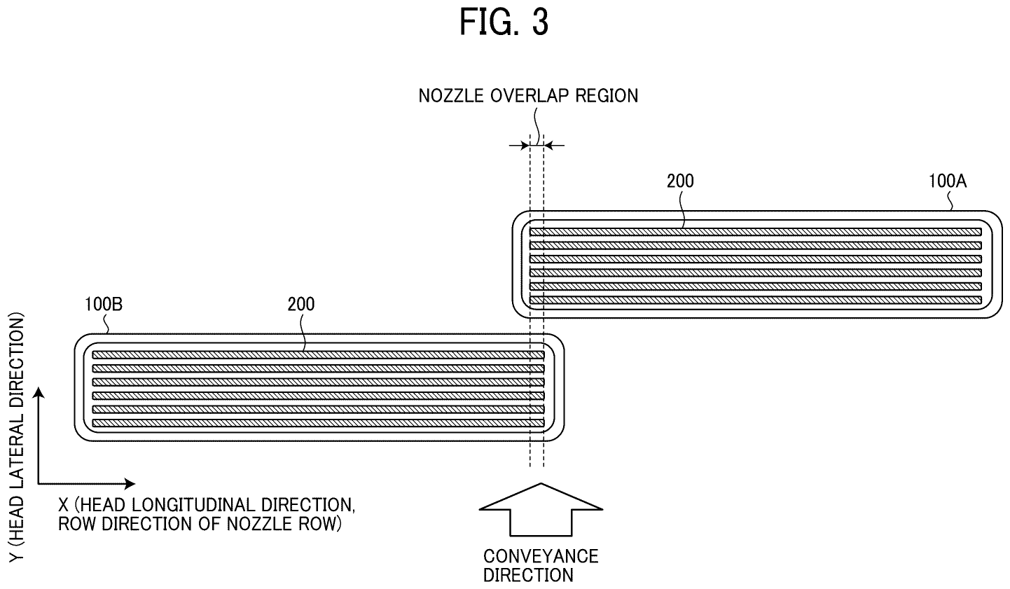

FIG. 3 is a plan view illustrating a configuration of a plurality of adjacent heads (head 100A and head 100B). The head 100A and the head 100B are line type heads including multiple nozzles aligned, which are discharge nozzles from which liquid is discharged. In this example, each head has six nozzle arrays, but the number of nozzle arrays is not limited to six. As illustrated in FIG. 3, the head 100A and the head 100B include a plurality of nozzle arrays 200 in which nozzles are arranged in a head longitudinal direction (X direction) in a head lateral direction (Y direction). The head 100A and the head 100B are configured to be installed by providing a nozzle overlap region where nozzles overlap each other at an end portion of the nozzle array in a nozzle array direction (X direction). The head lateral direction (Y direction) is also referred to as a “transverse direction” intersecting the nozzle array direction (X direction).

Here, immediately below each nozzle, a conveyance airflow is generated in the same direction as the conveyance direction of the medium 10. The conveyance airflow is accelerated in proportion to the conveyance speed of the medium 10. The “conveyance direction” is a direction in which the medium 10 moves relative to the head.

In the present embodiment, an example in which the line type inkjet recording apparatus is applied as the printing apparatus 1000 has been described, but the present embodiment is not limited thereto, and can be similarly applied to a serial type (shuttle type) ink jet recording apparatus scanned by a carriage. In either the line type or the serial type, in the present embodiment, the head on the downstream side (medium downstream side) in the relative movement direction of the medium 10 with respect to the liquid discharge head is referred to as the head 100A, and the head on the upstream side (medium upstream side) is referred to as the head 100B.

Next, a system configuration of the printing apparatus 1000 will be described.

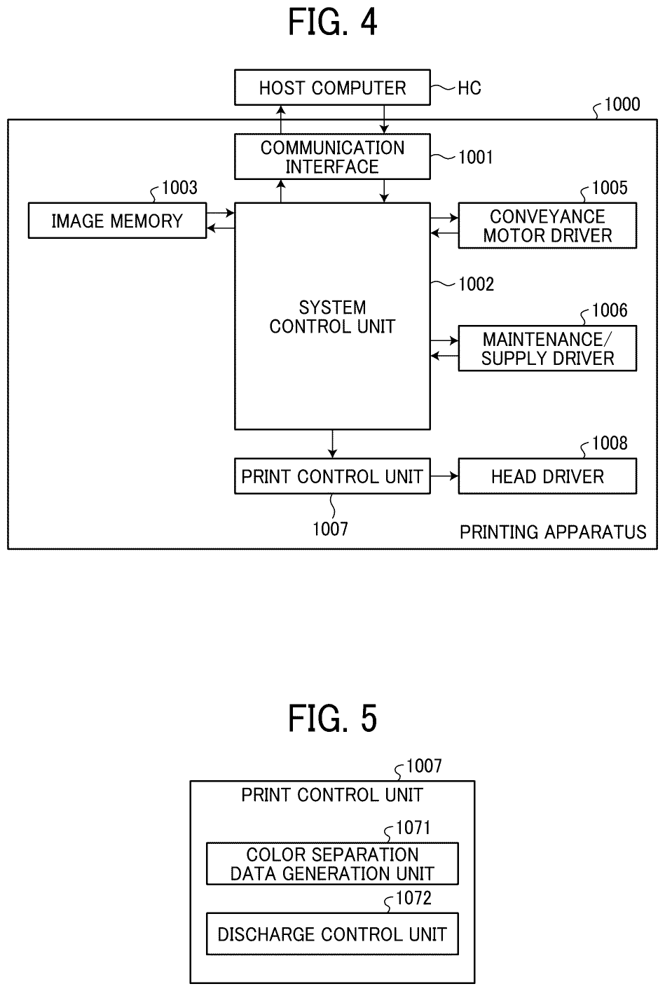

FIG. 4 is a block diagram illustrating a system configuration example of the printing apparatus 1000. As illustrated in FIG. 4, the printing apparatus 1000 includes a communication interface 1001, a system control unit 1002, an image memory 1003, a conveyance motor driver 1005, a maintenance/supply driver 1006, a print control unit 1007, a head driver 1008, and the like.

The communication interface 1001 is an interface unit that receives image data transmitted from a host computer HC. The image data transmitted from the host computer HC is taken into the printing apparatus 1000 via the communication interface 1001 and temporarily stored in the image memory 1003.

The image memory 1003 is a storage unit that temporarily stores image data input via the communication interface 1001. The image memory 1003 reads and writes data through the system control unit 1002.

The system control unit 1002 includes a central processing unit (CPU), peripheral circuits thereof, and the like. The system control unit 1002 functions as a control device that controls the entire printing apparatus 1000 according to a predetermined program, and functions as an arithmetic device that performs various calculations. That is, the system control unit 1002 controls each unit such as the communication interface 1001, the image memory 1003, the conveyance motor driver 1005, and the maintenance/supply driver 1006. The system control unit 1002 controls the print control unit 1007 to drive the head to discharge liquid.

The image memory 1003 stores programs executed by the CPU of the system control unit 1002, various data necessary for control, and the like. The image memory 1003 is used as a temporary storage area of image data, and is also used as a development area of a program and a calculation work area of the CPU.

The conveyance motor driver 1005 is a driver that drives motors and the like provided in the carry-in unit 1, the guide conveyance unit 3, the discharging unit 9, and the like in accordance with an instruction from the system control unit 1002.

The maintenance/supply driver 1006 is a driver that drives a supply system block that controls the driving of a liquid feeding pump and an electromagnetic valve group for the heads 100A and 100B and a maintenance system block that controls the driving of a suction pump and an electromagnetic valve group connected to caps of the heads 100A and 100B according to an instruction from the system control unit 1002.

The print control unit 1007 has a signal processing function of performing processing such as various processing and correction for generating a signal for print control from the image data in the image memory 1003 in accordance with an instruction from the system control unit 1002. The print control unit 1007 is a control unit that supplies generated print data (dot data) to the head driver 1008. The print control unit 1007 controls discharge droplet amounts (droplet amounts) and discharge timings of the heads 100A and 100B via the head driver 1008 based on the image data subjected to necessary signal processing. Thus, a desired dot size and dot arrangement are implemented.

The head driver 1008 includes a drive circuit that generates a drive signal to be applied to the piezoelectric elements of the heads 100A and 100B on the basis of the image data given from the print control unit 1007, and applies the drive signal to the piezoelectric elements to drive the piezoelectric elements.

FIG. 5 is a functional block diagram related to droplet discharge control of each nozzle by the print control unit 1007. The print control unit 1007 includes a color separation data generation unit 1071 and a discharge control unit 1072. The discharge control unit 1072 schematically controls discharge of liquid (droplets).

When image data to be printed is input, the color separation data generation unit 1071 generates color separation data for each color of liquid mounted on the printing apparatus 1000 from the input image data. For example, when the printing apparatus 1000 performs printing using CMYK liquids, the color separation data generation unit 1071 generates color separation data of each color of CMYK from the input image data.

The discharge control unit 1072 generates print dot data by applying a dot data generation mask to the color separation data of each color generated by the color separation data generation unit 1071. Here, the dot data generation mask is, for example, a mask pattern for forming an image by mixing print dots by two heads in the nozzle overlap region at the end portions of the adjacent heads 100A and 100B. The discharge control unit 1072 is an example of a control unit that controls discharge of droplets from the nozzle.

The liquid disposed on the medium 10 forms dots in the image by being fixed to the medium 10. More specifically, after one liquid droplet formed by the liquid discharged from the head 100A or 100B lands on the medium 10, the liquid droplet is dried and fixed to the medium 10 to form one dot (landing dot) in the image. Then, an image is formed as an aggregate of a plurality of landing dots. In the present embodiment, a portion including the heads 100A and 100B and the print control unit 1007 and the head driver 1008, which are functional units that control the heads, may be referred to as a liquid discharge apparatus. The liquid discharge apparatus in this case is an apparatus included in the printing apparatus 1000.

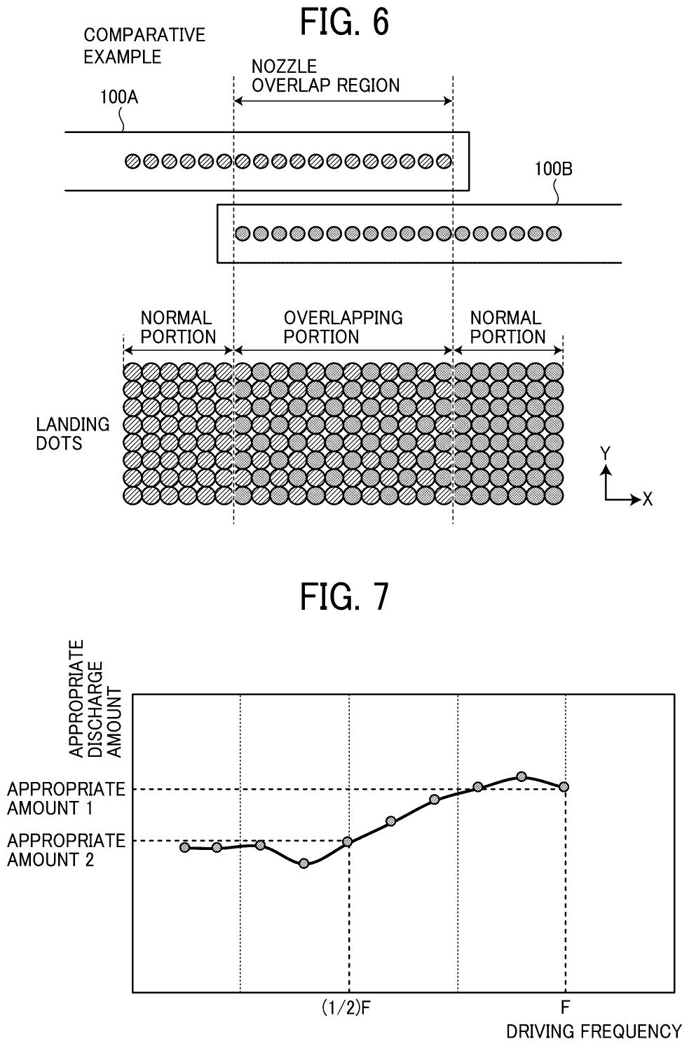

Next, degradation in image quality occurring in the nozzle overlap region when a mask pattern of a comparative example is used as the dot data generation mask will be described with reference to FIGS. 6 to 9.

FIG. 6 is a diagram illustrating an example of landing dots of the comparative example in the periphery of the nozzle overlap region. In FIG. 6, the number of nozzles in the nozzle overlap region is 12 for both the heads 100A and 100B, but may be larger or smaller than this. The landing dots illustrated in FIG. 6 indicate the state of the dots when the droplets discharged from the heads 100A and 100B land on an ideal position of the medium 10. A normal portion of landing dots on the left side is formed by droplets (discharge droplets) discharged from the head 100A, and a normal portion on the right side is formed by discharge droplets from the head 100B. An overlapping portion of landing dots is formed by discharge droplets from the nozzles in the nozzle overlap region of the heads 100A and 100B. That is, in the overlap region, discharge nozzles that discharge a droplet and non-discharge nozzles that do not discharge a droplet are selected using the mask pattern, and the overlapping portion of landing dots is formed by the discharge droplets from each of the heads.

Here, the length of the overlapping portion in the X direction is 12 nozzles, but since an image can be formed by a total of 24 nozzles of 12 nozzles of the head 100A and 12 nozzles of the head 100B in the nozzle overlap region, there are twice as many nozzles as the normal portion. The overlapping portion in FIG. 6 is formed by a process of alternately arranging dots formed by the head 100A and the head 100B in both the X direction and the Y direction. By this processing, in the overlapping portion, an image is formed by mixing dots formed by the two heads, and it is possible to reduce image quality deterioration due to variations in discharge characteristics of the head 100A and the head 100B, concentration unevenness due to landing shift due to airflow at a head end portion, streaks, and the like.

However, in general, the discharge droplet amount of the head varies according to the driving frequency. FIG. 7 is a graph illustrating an example of a relationship between a driving frequency and an appropriate discharge amount. In FIG. 7, it is illustrated that the appropriate discharge amount which is a droplet amount of 1 at a driving frequency F decreases to a droplet amount of 2 when the driving frequency becomes ½.

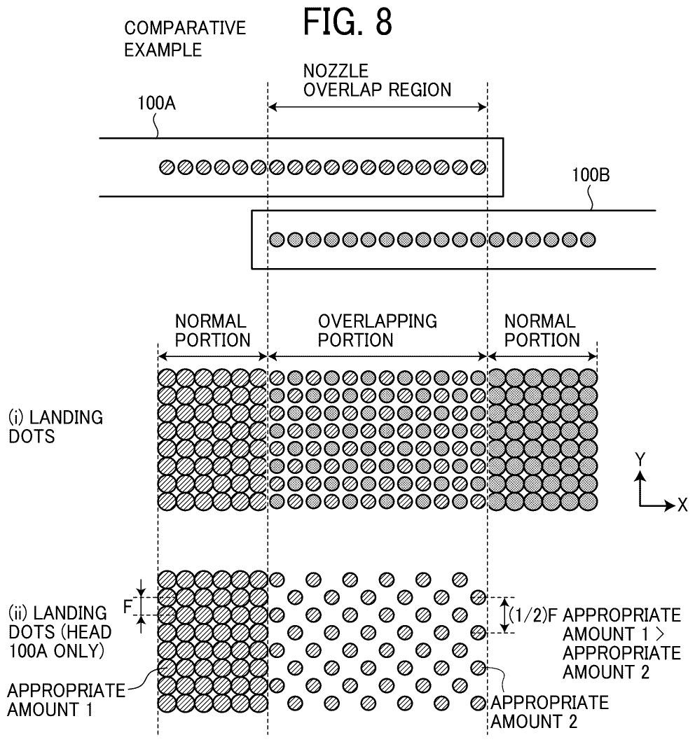

FIG. 8 is a diagram illustrating an example of landing dots of the comparative example formed when the appropriate discharge amount is decreased.

Here, “(i) landing dots” indicate dots from two heads, and “(ii) landing dots” indicate only dots from the head 100A. As illustrated in FIG. 8, since the normal portion is formed of dots of a droplet amount 1 and the overlapping portion is formed of dots of a droplet amount 2, the overlapping portion is visually recognized to be thinner than the normal portion, and white unevenness occurs.

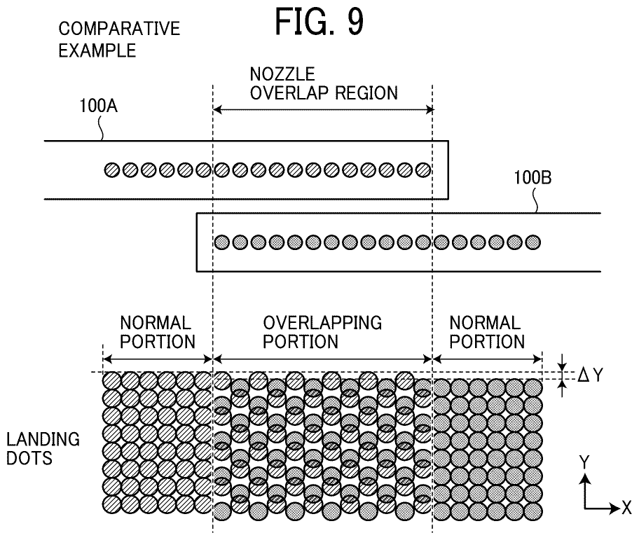

Positional deviation or a difference in droplet speed between the two heads may occur, and landing positions of dots of one head may be relatively shifted. FIG. 9 is a diagram illustrating an example of landing dots when droplets from the head 100A and the head 100B overlap and land in the overlapping portion. This is an example in which the landing dots from the head 100B are shifted by ΔY in the Y direction in the overlapping portion. When such shift of the landing positions occurs, the same concentration as the concentration of the normal portion cannot be ensured in the overlapping portion, and it is visually recognized as image quality degradation such as concentration unevenness and streaks. Furthermore, the shift of the landing positions may occur due to the influence of self-airflow or conveyance airflow generated when the droplets are discharged.

In the present embodiment, a plurality of nozzle arrays is arranged in each head, and the discharge nozzles that discharge droplets and the non-discharge nozzles that do not discharge droplets are controlled, thereby reducing the degradation of the image quality described above.

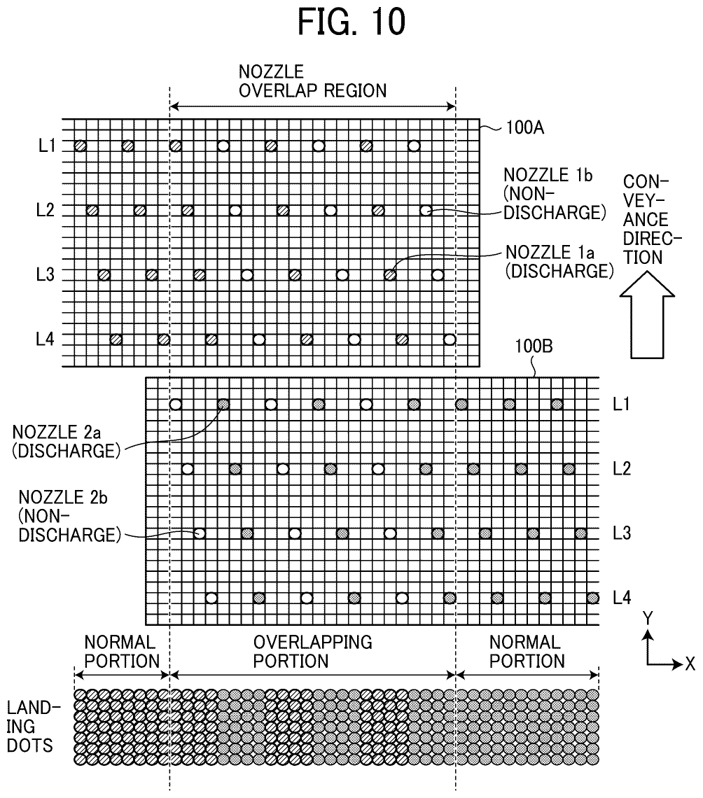

FIG. 10 is a diagram illustrating an example of a mask pattern and formed landing dots according to the present embodiment. Here, in the heads 100A and 100B, four nozzle arrays of L1 rows to L4 rows are arranged (such a head is referred to as a “four-row head”). In the nozzles of each nozzle array of the head 100A, discharge nozzles 1a and non-discharge nozzles 1b are alternately arranged in the nozzle overlap region. Similarly, in the nozzles of each nozzle array of the head 100B, discharge nozzles 2a and non-discharge nozzles 2b are alternately arranged in the nozzle overlap region. The nozzles of the Ln rows (n=1 to 4) of the head 100A and the head 100B are arranged on a straight line in the Y direction.

In this manner, by alternately arranging the discharge nozzles and the non-discharge nozzles in the nozzle array and arranging the nozzles in a predetermined nozzle array (in the same row) of one head and the nozzles in a predetermined nozzle array (in the same row) of the other head in a straight line in the transverse direction (Y direction) orthogonal to the nozzle array direction (X direction), the density of the nozzles in the head can be reduced.

This makes it possible to reduce concentration unevenness due to the self-airflow. In the nozzle overlap region, since the non-discharge nozzles included in each nozzle array are arranged in an oblique direction inclined to the nozzle array direction (X direction), the conveyance airflow can be efficiently released, and the landing shift and the concentration unevenness due to the airflow can be reduced.

In the nozzle overlap region, the plurality of droplets that land in the transverse direction (Y direction) orthogonal to (or intersecting) the nozzle array direction is discharged, from only the nozzles of the head 100A or only the nozzles of the head 100B, so that landing dots as illustrated in FIG. 10 are formed. Since the driving frequency of each nozzle is the same in the overlapping portion and the normal portion, it is possible to reduce image quality degradation due to the difference in the driving frequency described above. Even if the shift of the landing dots in the Y direction occurs, the dots of the two heads do not overlap and land, and it is possible to reduce image quality degradation such as concentration unevenness and streaks as illustrated in FIG. 9.

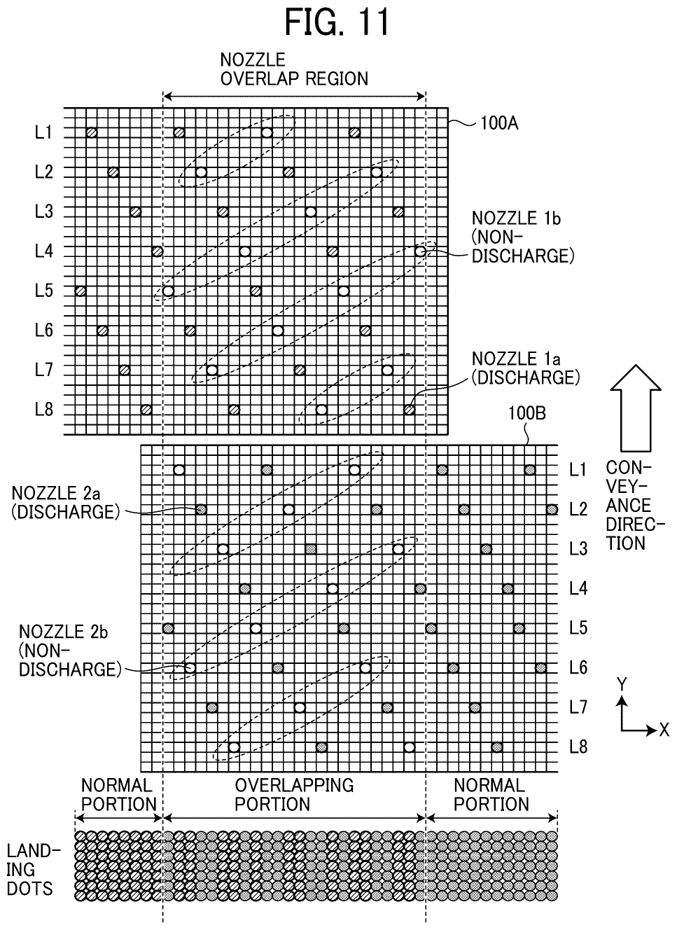

FIG. 11 is a diagram illustrating another example of the mask pattern and the formed landing dots according to the present embodiment. Here, in the heads 100A and 100B, eight nozzle arrays of L1 row to L8 row are arranged (such heads are referred to as “eight-row heads”). In the nozzles of each nozzle array of the head 100A, discharge nozzles 1a and non-discharge nozzles 1b are alternately arranged in the nozzle overlap region. Similarly, in the nozzles of each nozzle array of the head 100B, discharge nozzles 2a and non-discharge nozzles 2b are alternately arranged in the nozzle overlap region. The nozzles of the Ln row (n=1 to 8) of the head 100A and the head 100B are arranged on a straight line in the Y direction. In the nozzles illustrated in FIG. 11, the pitch in the X direction (the interval between the nozzles included in the nozzle array) is larger than the pitch in the Y direction (the interval between the nozzle arrays).

When the resolution of the landing dots same as the resolution of the landing dots of the 4-row head as illustrated in FIG. 10 is implemented using the 8-row head, the number of nozzles (nozzle density) in the X direction can be halved as compared with the 4-row head, so that the effect of preventing the concentration unevenness due to the self-airflow can be enhanced. When the same resolution is implemented, the nozzle density in the X direction can be reduced as the number of nozzle arrays is increased, but since the size of the head is increased when the number of nozzle arrays is large, the number of nozzle arrays is desirably in a range of 6 to 10.

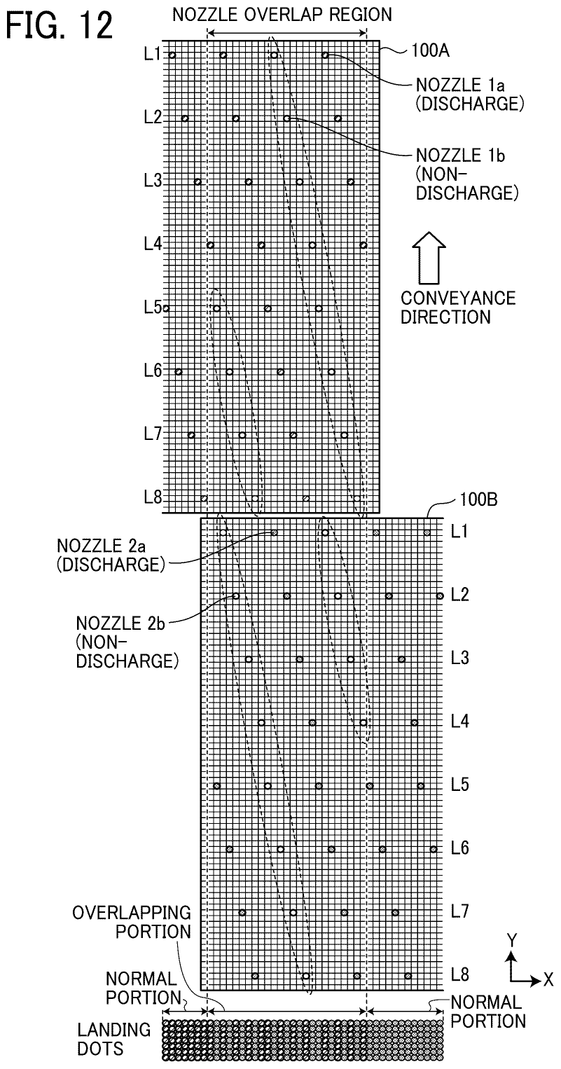

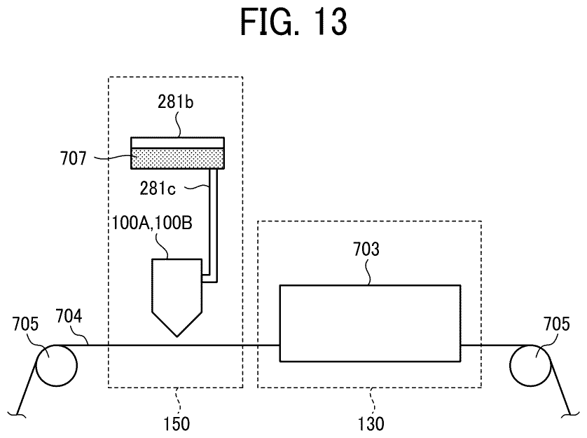

FIG. 12 is a diagram illustrating another example of the mask pattern and the formed landing dots according to the present embodiment. The difference from the example illustrated in FIG. 11 is that the pitch in the X direction (the interval between the nozzles included in the nozzle array) is smaller than the pitch in the Y direction (the interval between the nozzle arrays).

In the case of using the mask pattern illustrated in FIG. 12, the inclination (direction) of the arrangement of the non-discharge nozzles indicated by a dashed ellipse approaches the conveyance direction of the medium 10 as compared with the case where the pitch in the X direction is larger than the pitch in the Y direction as illustrated in FIG. 11, and thus the conveyance airflow can be more efficiently released. Thus, it is possible to enhance the effect of reducing image quality deterioration such as landing shift and concentration unevenness caused by the conveyance airflow.

As described above, according to the present embodiment, it is possible to prevent deterioration in image quality in the overlapping range of the two heads.

### Second Embodiment

Next, a second embodiment will be described. Hereinafter, in the description of the second embodiment, description of the same portions as the portions of the first embodiment will be omitted, and portions different from the portions of the first embodiment will be described.

### Electrode Manufacturing Apparatus

A printing apparatus 1000 that is the liquid discharge apparatus according to the present embodiment also includes an apparatus for manufacturing an electrode and an electrochemical element. The electrode manufacturing apparatus is described below.

FIG. 13 is a schematic view illustrating an example of the electrode manufacturing apparatus according to the second embodiment. The electrode manufacturing apparatus is an apparatus of manufacturing an electrode including a layer containing an electrode material by discharging a liquid composition using a head module including the liquid discharge heads 100A and 100B described in the first embodiment.

### Unit of Forming Layer Containing Electrode Material and Process of Forming Layer Containing Electrode Material

The electrode manufacturing apparatus illustrated in FIG. 13 has a discharging unit that is a head module according to the present embodiment. The liquid composition is discharged from the discharge head of the head module, and thus the liquid composition is applied onto the target object, and a liquid composition layer is formed. The target (hereinafter, may be referred to as “discharge target”) is not particularly limited and may be appropriately selected depending on the intended purpose, as long as the target is a target on which a layer containing an electrode material is to be formed. Examples of the target include an electrode substrate (current collector), an active material layer, and a layer containing a solid electrode material. The target may be an electrode mixture layer containing an active material on an electrode substrate (current collector). The discharging unit and the discharging process may be a device and a process of forming a layer containing an electrode material by directly discharging a liquid composition as long as the layer containing an electrode material can be formed on a discharge target. The discharging unit and the discharging process may be a unit and a process of forming a layer containing an electrode material by indirectly discharging a liquid composition.

### Other Configurations and Other Processes

Other configurations included in a manufacturing apparatus of an electrode mixture layer are not particularly limited as long as the effects of the present embodiment are not impaired, and can be appropriately selected according to a purpose. Other processes included in a method for manufacturing an electrode mixture layer are not particularly limited as long as the effects of the present embodiment are not impaired, and can be appropriately selected according to a purpose. For example, a heating unit and a heating process are examples of the configuration and the process included in the manufacturing apparatus and the method for manufacturing the electrode mixture layer.

### Heating Unit and Heating Process

The heating unit included in the manufacturing apparatus of an electrode mixture layer is a unit that heats the liquid composition discharged by the discharging unit. The heating process included in the method for manufacturing an electrode mixture layer is a process of heating the liquid composition discharged in the discharging process. The liquid composition is heated to dry the liquid composition layer.

### Structure to Form a Layer Containing Electrode Material by Direct Discharge of Liquid Composition

As an example of the electrode manufacturing apparatus, an electrode manufacturing apparatus for forming an electrode mixture layer containing an active material on an electrode substrate (current collector) is described below. As illustrated in FIG. 13, the electrode manufacturing apparatus includes a discharging process unit 150 and a heating process unit 130. The discharging process unit 150 performs a discharging process of applying a liquid composition onto a printing base material 704 having a discharge target to form a liquid composition layer. The heating process unit 130 performs a heating process of heating the liquid composition layer to obtain an electrode mixture layer.

The electrode manufacturing apparatus includes a conveyor 705 that conveys the printing base material 704. The conveyor 705 conveys the printing base material 704 to the discharging process unit 150 and the heating process unit 130 in this order at a preset speed. A method for manufacturing the printing base material 704 having the discharge target such as an active material layer is not particularly limited, and a known method can be appropriately selected. The discharging process unit 150 includes the liquid discharge heads 100A and 100B that performs an application process of applying the liquid composition onto the printing base material 704, a storage container 281b that stores a liquid composition 707, and a supply tube 281c that supplies the liquid composition 707 stored in the storage container 281b to the liquid discharge heads 100A and 100B.

The discharging process unit 150 discharges the liquid composition 707 from the liquid discharge heads 100A and 100B so that the liquid composition 707 is applied onto the printing base material 704 to form a liquid composition layer in a thin film shape. The storage container 281b may be integrated with the manufacturing apparatus of the electrode mixture layer, or may be detachable from the manufacturing apparatus of the electrode mixture layer. The storage container 281b may be a container used for adding to the storage container integrated with the manufacturing apparatus of the electrode mixture layer or detachable from the manufacturing apparatus of the electrode mixture layer.

The storage container 281b that stably stores the liquid composition 707 and the supply tube 281c that stably supplies the liquid composition 707 can be used.

The heating process unit 130 performs a solvent removal process of heating and removing the solvent remaining in the liquid composition layer. Specifically, the solvent remaining in the liquid composition layer is heated and dried by a heating device 703 of the heating process unit 130, and thus the solvent is removed from the liquid composition layer.

Thus, the electrode mixture layer is formed. The solvent removal process in the heating process unit 130 may be performed under reduced pressure.

The heating device 703 is not particularly limited and may be appropriately selected depending on the intended purpose.

For example, the heating device 703 may be a substrate heater, an infrared (IR) heater, a hot air heater, or the like.

The heating device 703 may be a combination of at least two of the substrate heater, the IR heater, and the hot air heater. A heating temperature and heating time can be appropriately selected according to a boiling point of the solvent contained in the liquid composition 707 or the thickness of a formed film.

The electrode manufacturing apparatus according to the embodiment of the present embodiment is used to discharge the liquid composition onto a desired target place of the discharge target. The electrode mixture layer can be suitably used as, for example, a part of the configuration of an electrochemical element. The configuration of the electrochemical element other than the electrode mixture layer is not particularly limited, and a known configuration can be appropriately selected. For example, as a configuration other than the electrode mixture layer, the electrochemical element may include a positive electrode, a negative electrode, a separator, for example.

The program executed by the printing apparatus 1000 that is the liquid discharge apparatus of the present embodiment is provided by being incorporated in a read only memory (ROM) or the like in advance.

The program executed by the printing apparatus 1000 that is the liquid discharge apparatus of the present embodiment may be provided by being recorded in a computer-readable recording medium such as a compact disc read only memory (CD-ROM), a flexible disk (FD), a compact disk recordable (CD-R), or a digital versatile disc (DVD) as a file in an installable format or an executable format.

Various programs executed by the printing apparatus 1000 that is the liquid discharge apparatus of the present embodiment may be stored in a computer connected to a network such as the Internet and provided by being downloaded via the network. The program executed by the printing apparatus 1000 that is the liquid discharge apparatus of the present embodiment may be provided or distributed via a network such as the Internet.

The program executed by the printing apparatus 1000 of the present embodiment has a module configuration including the above-described units (the color separation data generation unit 1071 and the discharge control unit 1072), and as actual hardware, the CPU (processor) reads the program from the storage medium and executes the program, so that the respective units are loaded on a main storage device, and the color separation data generation unit 1071 and the discharge control unit 1072 are generated on the main storage device.

It is possible to implement each of the functions (the color separation data generation unit 1071 and the discharge control unit 1072) of the embodiment described above by one processing circuit or a plurality of processing circuits. Here, the term “processing circuit” in the present description includes a processor programmed to execute each function by software, such as a processor implemented by an electronic circuit, and devices, such as an application specific integrated circuit (ASIC), a digital signal processor (DSP), a field programmable gate array (FPGA), and a conventional circuit module arranged to execute each function described above.

A liquid discharge apparatus includes: a first head including first nozzle arrays each including first nozzles arrayed in a nozzle array direction to discharge droplets from the first nozzles to a medium; and a second head including second nozzle arrays each including second nozzles arrayed in the nozzle array direction to discharge droplets from the second nozzles to a medium; and circuitry configured to control the first head and the second head to discharge the droplets from the first nozzles and the second nozzles, respectively. The first head and the second head are adjacent to each other in a transverse direction intersecting the nozzle array direction, the first head has a first overlap region at one end of the first head in the nozzle array direction, the second head has a second overlap region overlapped with the first overlap region in the transverse direction, the second overlap region at another end of the second head opposite to the one end of the first head in the nozzle array direction, the first nozzles, arrayed in the same row in the nozzle array direction in each of the first nozzle arrays, and the second nozzles, arrayed in the same row in the nozzle array direction in each of the second nozzle arrays, are arrayed in a straight line in the transverse direction, and the circuitry is further configured to, in each of the first overlap region and the second overlap region: cause one of the first head or the second head to: discharge the droplets from only one of the first nozzles in the same row of each of the first nozzle arrays or the second nozzles in the same row of each of the second nozzle arrays, to land the droplets arrayed in the straight line in the transverse direction on the medium; alternately discharge or non-discharge the droplets from the first nozzles in the nozzle array direction in each of the first nozzle arrays; and alternately discharge or non-discharge the droplets from the second nozzles in the nozzle array direction in each of the second nozzle arrays.

The first nozzles in the same row of each of the first nozzle arrays are arrayed in an oblique direction inclined to the nozzle array direction, and the second nozzles in the same row of each of the second nozzle arrays that are selected to be non-discharge nozzles are arrayed in the oblique direction inclined to the nozzle array direction.

A number of each the first nozzle arrays in the first head are in a range of six to ten, and a number of each the second nozzle arrays in the second head are in the range of six to ten.

An interval between the first nozzles in each of the first nozzle arrays in the nozzle array direction is smaller than an interval between the first nozzle arrays in the transverse direction, and an interval between the second nozzles in each of the second nozzle arrays in the nozzle array direction is smaller than an interval between the second nozzle arrays in the transverse direction.

A printing apparatus includes: the liquid discharge apparatus; a system controller configured to drive the liquid discharge apparatus to discharge the droplets to the medium; and a conveyor to convey the medium to the liquid discharge apparatus.

A liquid discharge method includes discharging droplets, to a medium, from first nozzles, arrayed in a nozzle array direction, in each of first nozzle arrays of a first head; discharging droplets, to a medium, from second nozzles, arrayed in the nozzle array direction, in each of second nozzle arrays of a second head; controlling the first head and the second head to discharge the droplets from the first nozzles and the second nozzles, respectively, causing one of the first head or the second head to, in each of a first overlap region in the first head and a second overlap region in the second head: discharge the droplets from only one of the first nozzles in the same row of each of the first nozzle arrays or the second nozzles in the same row of each of the second nozzle arrays, to land the droplets arrayed in a straight line in a transverse direction intersecting the nozzle array direction on the medium; alternately discharge or non-discharge the droplets from the first nozzles in the nozzle array direction in each of the first nozzle arrays; and alternately discharge or non-discharge the droplets from the second nozzles in the nozzle array direction in each of the second nozzle arrays.

The first head and the second head are adjacent to each other in the transverse direction, the first head has the first overlap region at one end of the first head in the nozzle array direction, the second head has the second overlap region overlapped with the first overlap region in the transverse direction, the second overlap region at another end of the second head opposite to the one end of the first head in the nozzle array direction, and the first nozzles, arrayed in the same row in the nozzle array direction in each of the first nozzle arrays, and the second nozzles, arrayed in the same row in the nozzle array direction in each of the second nozzle arrays, are arrayed in the straight line in the transverse direction.

A non-transitory recording medium storing a plurality of instructions which, when executed by one or more processors, causes the one or more processors to perform a method in a computer that controls a liquid discharge head, includes discharging droplets, to a medium, from first nozzles, arrayed in a nozzle array direction, in each of first nozzle arrays of a first head; discharging droplets, to a medium, from second nozzles, arrayed in the nozzle array direction, in each of second nozzle arrays of a second head; controlling the first head and the second head to discharge the droplets from the first nozzles and the second nozzles, respectively, causing one of the first head or the second head to, in each of a first overlap region in the first head and a second overlap region in the second head: discharge the droplets from only one of the first nozzles in the same row of each of the first nozzle arrays or the second nozzles in the same row of each of the second nozzle arrays, to land the droplets arrayed in a straight line in a transverse direction intersecting the nozzle array direction on the medium; alternately discharge or non-discharge the droplets from the first nozzles in the nozzle array direction in each of the first nozzle arrays; and alternately discharge or non-discharge the droplets from the second nozzles in the nozzle array direction in each of the second nozzle arrays.

The first head and the second head are adjacent to each other in the transverse direction, the first head has the first overlap region at one end of the first head in the nozzle array direction, the second head has the second overlap region overlapped with the first overlap region in the transverse direction, the second overlap region at another end of the second head opposite to the one end of the first head in the nozzle array direction, and the first nozzles, arrayed in the same row in the nozzle array direction in each of the first nozzle arrays, and the second nozzles, arrayed in the same row in the nozzle array direction in each of the second nozzle arrays, are arrayed in the straight line in the transverse direction.

In the present application, the “liquid discharge apparatus” includes the liquid discharge head or the liquid discharge unit and drives the liquid discharge head to discharge a liquid. The liquid discharge apparatus may be, in addition to apparatuses to discharge liquid to materials onto which liquid can adhere, apparatuses to discharge the liquid into gas or another liquid.

The “liquid discharge apparatus” may include a unit regarding feeding, conveyance, and discharge of a material onto which liquid can adhere, a pretreatment apparatus, and a post-treatment apparatus.

The “liquid discharge apparatus” may be, for example, an image forming apparatus to form an image on a sheet by discharging ink, or a three-dimensional fabrication apparatus to discharge a fabrication liquid to a powder layer in which powder material is formed in layers to form a three-dimensional fabrication object.

The term “liquid discharge apparatus” is not limited to an apparatus to discharge liquid to visualize meaningful images, such as letters or figures. For example, the liquid discharge apparatus may be an apparatus to form meaningless images, such as meaningless patterns, or fabricate three-dimensional images.

The above-described term “material onto which liquid can adhere” represents a material on which liquid is at least temporarily adhered, a material on which liquid is adhered and fixed, or a material into which liquid is adhered to permeate. Examples of the “material onto which liquid can adhere” include recording media, such as paper sheet, recording paper, recording sheet of paper, film, and cloth, electronic component, such as electronic substrate and piezoelectric element, and media, such as powder layer, organ model, and testing cell. The “material on which liquid can adhere” includes any material on which liquid can adhere, unless particularly limited.

Examples of the “material onto which liquid can adhere” include any materials on which liquid can adhere even temporarily, such as paper, thread, fiber, fabric, leather, metal, plastic, glass, wood, and ceramic.

The term “liquid” includes any liquid having a viscosity or a surface tension that is dischargeable from the head. However, preferably, the viscosity of the liquid is not greater than 30 mPa's under ordinary temperature and ordinary pressure or by heating or cooling. Examples of the liquid include a solution, a suspension, or an emulsion including, for example, a solvent, such as water or an organic solvent, a colorant, such as dye or pigment, a functionality imparting material, such as a polymerizable compound, a resin, a surfactant, a biocompatible material, such as deoxyribonucleic acid (DNA), amino acid, protein, or calcium, and an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

The “liquid discharge apparatus” may be an apparatus to relatively move the liquid discharge head and a material onto which liquid can adhere. However, the liquid discharge apparatus is not limited to such an apparatus. Specific examples include a serial type apparatus which moves the liquid discharge head, and a line type apparatus which does not move the liquid discharge head.

Examples of the “liquid discharge apparatus” further include a treatment liquid applying apparatus that discharges a treatment liquid onto a sheet to apply the treatment liquid to the surface of the sheet for the purpose of modifying the surface of the sheet, and an ejection granulating apparatus that ejects a composition liquid in which a raw material is dispersed in a solution through a nozzle to granulate fine particles of the raw material.

According to the present embodiment, it is possible to prevent deterioration in image quality in an overlapping range of two heads.

Finally, the embodiment described above has been presented as an example, and there is no intention of limiting the scope of the present embodiment. It is possible to implement the new embodiment in various other forms, and it is possible to make various omissions, substitutions, and changes without departing from the gist of the present embodiment. The embodiment and the modification examples of the embodiment are included within the scope and gist of the present embodiment, and are also included within the present embodiment described in the claims and the equivalent scope.

Aspects of the present embodiment are, for example, as follows.

### First Aspect

According to a first aspect, a liquid discharge apparatus includes: multiple heads that includes a plurality of arranged nozzle arrays each including multiple nozzles and that selectively discharges droplets from the nozzles to a medium; and a control unit that controls discharge of the droplets from the nozzles, the heads including a first head and a second head adjacent to each other being installed with a nozzle overlap region provided at an end portion in a nozzle array direction of the nozzle arrays, nozzles in a predetermined nozzle array of the first head and nozzles in a predetermined nozzle array of the second head being arranged on a straight line orthogonal to the nozzle arrays, and in the nozzle overlap region, the control unit discharging a plurality of droplets that land in a direction orthogonal to the nozzle arrays, from only a nozzle of the first head or only a nozzle of the second head, discharge nozzles that discharge a droplet and non-discharge nozzles that do not discharge a droplet being alternately arranged in each of the nozzle arrays, and the non-discharge nozzles included in the plurality of nozzle arrays being arranged in an oblique direction with respect to the nozzle arrays.

### Second Aspect

According to a second aspect, in the liquid discharge apparatus of the first aspect, a number of the nozzle arrays included in each of the heads is in a range of 6 to 10.

### Third Aspect

According to a third aspect, in the liquid discharge apparatus of the first aspect or the second aspect, an interval between the nozzles included in each of the nozzle arrays is smaller than an interval between the nozzle arrays.

### Fourth Aspect

According to a fourth aspect, a printing apparatus includes: the liquid discharge apparatus of any one of the first aspect to the third aspect; a system control unit that drives the liquid discharge apparatus to discharge liquid; and a conveyance unit that conveys the medium.

### Fifth Aspect

According to a fifth aspect, a liquid discharge method in a liquid discharge head includes multiple heads that includes a plurality of arranged nozzle arrays each including multiple nozzles and that selectively discharges droplets from the nozzles to a medium, a first head and a second head adjacent to each other being installed with a nozzle overlap region provided at an end portion in a nozzle array direction of the nozzle array, nozzles in a predetermined nozzle array of the first head and nozzles in a predetermined nozzle array of the second head being arranged on a straight line orthogonal to the nozzle arrays in the nozzle overlap region, the liquid discharge method including: controlling discharge of droplets from the nozzles, the controlling including, in the nozzle overlap region: discharging a plurality of droplets that land in a direction orthogonal to the nozzle arrays, from only a nozzle of the first head or only a nozzle of the second head, discharge nozzles that discharge a droplet and non-discharge nozzles that do not discharge a droplet being alternately arranged in each of the nozzle arrays, and the non-discharge nozzles included in the plurality of nozzle arrays being arranged in an oblique direction with respect to the nozzle arrays.

### Sixth Aspect

According to a sixth aspect, a non-transitory recording medium stores a plurality of instructions which, when executed by one or more processors, causes the one or more processors to perform a method in a computer that controls a liquid discharge head, the liquid discharge head including multiple heads that includes a plurality of arranged nozzle arrays each including multiple nozzles and that selectively discharges droplets from the nozzles to a medium, the heads including a first head and a second head adjacent to each other being installed with a nozzle overlap region provided at an end portion in a nozzle array direction of the nozzle arrays, and nozzles in a predetermined nozzle array of the first head and nozzles in a predetermined nozzle array of the second head being arranged on a straight line orthogonal to the nozzle arrays in the nozzle overlap region, the method causing the computer to function as a control unit that drives the head to discharge liquid, and in the nozzle overlap region, the control unit discharging a plurality of droplets that land in a direction orthogonal to the nozzle arrays, from only a nozzle of the first head or only a nozzle of the second head, discharge nozzles that discharge a droplet and non-discharge nozzles that do not discharge a droplet being alternately arranged in each of the nozzle arrays, and the non-discharge nozzles included in the plurality of nozzle arrays being arranged in an oblique direction with respect to the nozzle arrays.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A liquid discharge apparatus comprising:
a first head including first nozzle arrays each including first nozzles arrayed in a nozzle array direction to discharge droplets from the first nozzles to a medium; and
a second head including second nozzle arrays each including second nozzles arrayed in the nozzle array direction to discharge droplets from the second nozzles to a medium; and
circuitry configured to control the first head and the second head to discharge the droplets from the first nozzles and the second nozzles, respectively,
wherein the first head and the second head are adjacent to each other in a transverse direction intersecting the nozzle array direction,
the first head has a first overlap region at one end of the first head in the nozzle array direction,
the second head has a second overlap region overlapped with the first overlap region in the transverse direction, the second overlap region at another end of the second head opposite to the one end of the first head in the nozzle array direction,
the first nozzles, arrayed in the same row in the nozzle array direction in each of the first nozzle arrays, and the second nozzles, arrayed in the same row in the nozzle array direction in each of the second nozzle arrays, are arrayed in a straight line in the transverse direction, and
the circuitry is further configured to, in each of the first overlap region and the second overlap region:
cause one of the first head or the second head to:
discharge the droplets from only one of the first nozzles in the same row of each of the first nozzle arrays or the second nozzles in the same row of each of the second nozzle arrays, to land the droplets arrayed in the straight line in the transverse direction on the medium;
alternately discharge or non-discharge the droplets from the first nozzles in the nozzle array direction in each of the first nozzle arrays; and
alternately discharge or non-discharge the droplets from the second nozzles in the nozzle array direction in each of the second nozzle arrays.

2. The liquid discharge apparatus according to claim 1,
wherein the first nozzles in the same row of each of the first nozzle arrays are arrayed in an oblique direction inclined to the nozzle array direction, and
the second nozzles in the same row of each of the second nozzle arrays that are selected to be non-discharge nozzles are arrayed in the oblique direction inclined to the nozzle array direction.

3. The liquid discharge apparatus according to claim 1,
wherein a number of each the first nozzle arrays in the first head are in a range of six to ten, and
a number of each the second nozzle arrays in the second head are in the range of six to ten.

4. The liquid discharge apparatus according to claim 1,
wherein an interval between the first nozzles in each of the first nozzle arrays in the nozzle array direction is smaller than an interval between the first nozzle arrays in the transverse direction, and
an interval between the second nozzles in each of the second nozzle arrays in the nozzle array direction is smaller than an interval between the second nozzle arrays in the transverse direction.

5. A printing apparatus comprising:
the liquid discharge apparatus according to claim 1;
a system controller configured to drive the liquid discharge apparatus to discharge the droplets to the medium; and
a conveyor to convey the medium to the liquid discharge apparatus.

6. A liquid discharge method comprising:
discharging droplets, to a medium, from first nozzles, arrayed in a nozzle array direction, in each of first nozzle arrays of a first head;
discharging droplets, to a medium, from second nozzles, arrayed in the nozzle array direction, in each of second nozzle arrays of a second head;
controlling the first head and the second head to discharge the droplets from the first nozzles and the second nozzles, respectively,
causing one of the first head or the second head to, in each of a first overlap region in the first head and a second overlap region in the second head:
discharge the droplets from only one of the first nozzles in the same row of each of the first nozzle arrays or the second nozzles in the same row of each of the second nozzle arrays, to land the droplets arrayed in a straight line in a transverse direction intersecting the nozzle array direction on the medium;
alternately discharge or non-discharge the droplets from the first nozzles in the nozzle array direction in each of the first nozzle arrays; and
alternately discharge or non-discharge the droplets from the second nozzles in the nozzle array direction in each of the second nozzle arrays,
wherein the first head and the second head are adjacent to each other in the transverse direction,
the first head has the first overlap region at one end of the first head in the nozzle array direction,
the second head has the second overlap region overlapped with the first overlap region in the transverse direction, the second overlap region at another end of the second head opposite to the one end of the first head in the nozzle array direction, and
the first nozzles, arrayed in the same row in the nozzle array direction in each of the first nozzle arrays, and the second nozzles, arrayed in the same row in the nozzle array direction in each of the second nozzle arrays, are arrayed in the straight line in the transverse direction.

7. A non-transitory recording medium storing a plurality of instructions which, when executed by one or more processors, causes the one or more processors to perform a method in a computer that controls a liquid discharge head, comprising:
discharging droplets, to a medium, from first nozzles, arrayed in a nozzle array direction, in each of first nozzle arrays of a first head;
discharging droplets, to a medium, from second nozzles, arrayed in the nozzle array direction, in each of second nozzle arrays of a second head;
controlling the first head and the second head to discharge the droplets from the first nozzles and the second nozzles, respectively,
causing one of the first head or the second head to in each of a first overlap region in the first head and a second overlap region in the second head:
discharge the droplets from only one of the first nozzles in the same row of each of the first nozzle arrays or the second nozzles in the same row of each of the second nozzle arrays, to land the droplets arrayed in a straight line in a transverse direction intersecting the nozzle array direction on the medium;
alternately discharge or non-discharge the droplets from the first nozzles in the nozzle array direction in each of the first nozzle arrays; and
alternately discharge or non-discharge the droplets from the second nozzles in the nozzle array direction in each of the second nozzle arrays,
wherein the first head and the second head are adjacent to each other in the transverse direction,
the first head has the first overlap region at one end of the first head in the nozzle array direction,
the second head has the second overlap region overlapped with the first overlap region in the transverse direction, the second overlap region at another end of the second head opposite to the one end of the first head in the nozzle array direction, and
the first nozzles, arrayed in the same row in the nozzle array direction in each of the first nozzle arrays, and the second nozzles, arrayed in the same row in the nozzle array direction in each of the second nozzle arrays, are arrayed in the straight line in the transverse direction.
